(19) United States
(12) Patent Application Publication
(10) Pub. No.: US 2007/0156587 A1
(43) Pub. Date: Jul. 5, 2007

(54) Content Protection Using Encryption Key Embedded with Content File

(75) Inventors: Frank Yu, Palo Alto, CA (US); Charles C. Lee, Cupertino, CA (US); Abraham C. Ma, Fremont, CA (US); Ming-Shiang Shen, Taipei Hsien (TW)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 11/677,658

(22) Filed: Feb. 22, 2007

Related U.S. Application Data
(63) Continuation-in-part of application No. 09/478,720, filed on Jan. 6, 2000.
(63) Continuation-in-part of application No. 11/466,759, filed on Aug. 23, 2006.
(63) Continuation-in-part of application No. 10/789,333, filed on Feb. 26, 2004, now abandoned.
(63) Continuation-in-part of application No. 11/668,316, filed on Jan. 29, 2007.

(51) Int. Cl. G06Q 99/00

(52) U.S. Cl. 705/50

(57) ABSTRACT

Content on a storage medium is protected from unauthorized use, such as excessive copying or expired playback. A storage medium contains encrypted content and an encrypted content key with rules such as usage and copy rules. An interface between a record/playback device and the storage medium has enhanced security by not passing unprotected encryption keys that might be intercepted by external hackers. A content key is combined with usage and copy rules and then encrypted with a unique key, and may be doubly-encrypted with a control key before transmission over the interface. The unique key is generated from a key matrix on the record/playback device using row and columns received from the storage medium. The storage medium stores a pre-loaded copy of the unique key. The control key is generated from a random number on the record/playback device and storage medium avoiding transmission over the interface.

### RELATED APPLICATION

This application is a continuation-in-part (CIP) of the co-pending application for “Electronic Data Storage Medium with Fingerprint Verification Capability”, U.S. Ser. No. 09/478,720, filed Jan. 6, 2000, and also “Flash Memory Controller For Electronic Data Flash Card”, U.S. Ser. No. 11/466,759, filed on Aug. 23, 2006, which is a CIP of “System and Method for Controlling Flash Memory”, U.S. Ser. No. 10/789,333, filed Feb. 26, 2004, now abandoned. This application is also a CIP of “MP3 Player with Digital Rights Management”, U.S. Ser. No. 11/668,316, filed Jan. 29, 2007.

This application also related to “Dual-Mode Flash Storage Exchange that Transfer Flash-Card Data to Removable USB Flash Key-Drive with or without a PC Host”, Ser. No. 10/707,835 A1, filed Jan. 15, 2004, now U.S. Pat. No. 6,993,618 and “USB smart switch with packet re-ordering for interleaving among multiple flash-memory endpoints aggregated as a single virtual USB endpoint”, Ser. No. 10/707,276 A1, filed Dec. 2, 2003, now U.S. Pat. No. 7,073,010.

### FIELD OF THE INVENTION

This invention relates to content-protection systems, and more particularly protecting the contents of a storage medium from unauthorized copying.

### BACKGROUND OF THE INVENTION

Computers have allowed the easy replication and distribution of computer files. This is useful when the contents of the computer files have limited appeal or value. However, entertainment-related content is quite valuable to the content producers. Videos, movies, songs, and electronic books are some examples of valuable content. Producers of these valuable content need to be paid for copies of their content, or they would not be able to cover the extensive costs of producing that content. If this valuable content were allowed to be freely copied using computers, the content providers would eventually stop producing their content.

Various digital rights management (DRM) and Content-Protection mechanisms have been devised to protect entertainment-related content. For example, Apple Computer has been able to convince music producers to make their songs available for downloading to portable music devices by including digital rights management (DRM) known as FairPlay. Content files are encrypted with a key to allow unlocking the content before playback by an authorized device. Microsoft Windows has another DRM system. The number of copies made by a computer can be limited to prevent widespread copying and distribution.

Computer files can be carried from one computer to another using floppy disks or diskettes. Data files stored on a floppy disk or diskette may require a password for access, or may use encryption to secure the data within the file. Confidential documents can be delivered over a network by adding safety seals and impressions. However, the confidential data is at risk due to breaking of the passwords, encryption codes, safety seals and impressions, thereby resulting in unsecure transfer of the information.

More recently, files are often transported by portable devices such as Universal-Serial-Bus (USB) key drives, memory cards, and music players such as Apple Computer's iPod and other MP3 devices. However, security of files on such devices is problematic. Illegal copies of copyrighted files are easy to make and distribute to potentially millions of other users.

The parent application, U.S. Ser. No. 09/478,720, disclosed an electronic data storage medium that had fingerprint verification capability. FIG. 1 is a schematic circuit block diagram illustrating an electronic data storage medium disclosed in the parent application.

The electronic data storage medium with fingerprint verification capability can be accessed by external computer 9 using input/output interface circuit 5, which may use a Personal-Computer Memory Card International Association (PCMCIA), RS-232, or similar interface. The electronic data storage medium can be located inside or outside of the external computer.

The electronic data storage medium is packaged in card body 1, and includes processing unit 2, memory device 3, fingerprint sensor 4, input/output interface circuit 5, display unit 6, power source 7, and function key set 8.

Memory device 3 can be a flash memory device that stores data files. Fingerprint sensor 4 scans a fingerprint of a user to generate fingerprint scan data. Processing unit 2 connects to other components and can operate in various modes, such as a programming mode, a data retrieving mode, and a data-resetting mode. Power source 7 supplies electrical power to processing unit 2. Function key set 8 allows the user to input a password that is verified by processing unit 2. Display unit 6 shows the operating status of the electronic data storage medium.

The electronic data storage medium packaged in card body 1 includes processing unit 2, memory device 3, and input/output interface circuit 5. While useful, various additions can increase the usefulness of the device. For example, audio playback can be supported. When coupled with fingerprint sensor 4, the audio playback can have added security features.

Memory device 3 may be a solid-state flash memory rather than a rotational hard drive. Using flash memory provides lighter weight, lower power, and more rigidity than the rotational hard drive. Data files such as audio, video, and text may need security. Also, alternative features such as audio/video capability may replace the fingerprint verification feature on some alternatives of the device.

While useful, existing content protection mechanisms have limitations. Hackers are constantly searching for ways to defeat DRM systems. More complex systems with multiple keys are desirable to strengthen content protection. Content protection is desirable for content files on a storage medium such as a digital-versatile disk (DVD), flash-memory card such as a Compact-Flash, Memory-Stick, Multi-Media Card/Secure Digital (MMC/SD), Universal-Serial-Bus (USB) flash-memory key drive, and computer hard and floppy disks.

What is desired is a content-protection system with enhanced security.

### BRIEF DESCRIPTION OF THE DRAWINGS

FIG. 1 is a schematic circuit block diagram illustrating an electronic data storage medium disclosed in the parent application.

FIG. 2 shows an electronic data storage medium device with video, audio, and fingerprint scanning capability.

FIG. 3 shows an electronic data storage medium device with video and audio capability without a fingerprint sensor.

FIG. 4 shows a content-protection mechanism that does not pass unencrypted keys between a recording and playback device and a storage medium.

FIG. 5 shows a content-protection mechanism enhanced by a control key generated from a random-number generator.

FIG. 6 shows a content-protection mechanism that compares local unique keys by encrypting a password.

FIG. 7 shows a content-protection mechanism that compares local unique keys by encrypting a password and uses a control key generated from a random-number generator.

FIG. 8 shows a content-protection mechanism that concatenates an encrypted tag with the encrypted content before transfer over a less-secure interface.

FIG. 9 highlights a content-protection mechanism using challenges and responses to generate a control key.

FIG. 10 shows a key matrix.

FIG. 11 shows three examples of key combinations.

### DETAILED DESCRIPTION

The present invention relates to an improvement in content protection. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

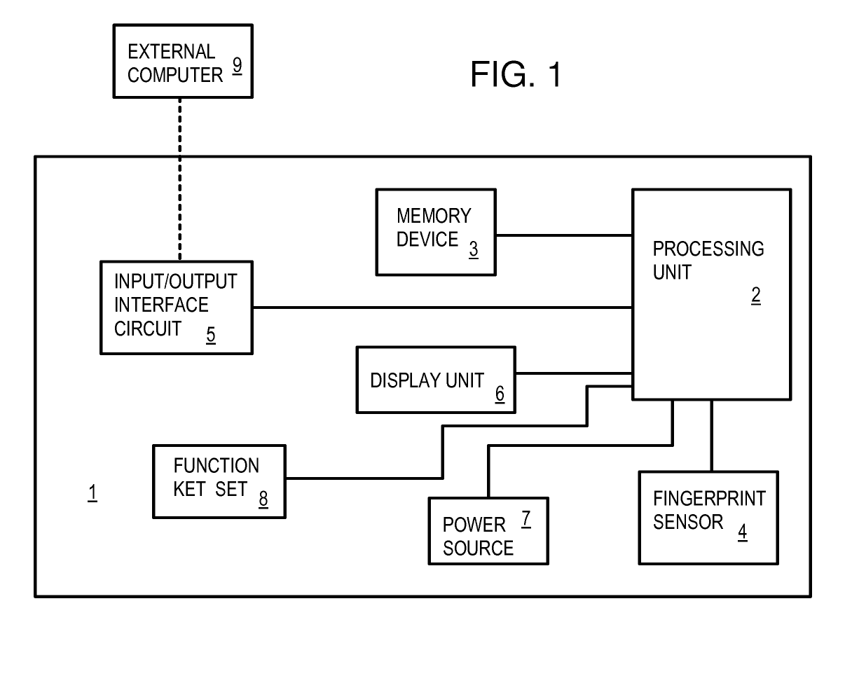

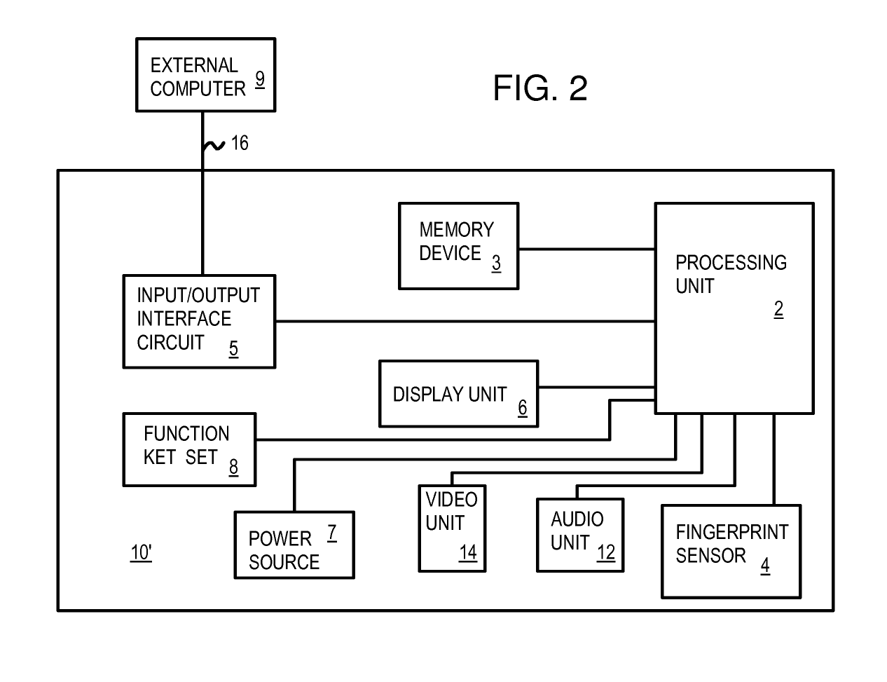

FIG. 2 shows an electronic data storage medium device with video, audio, and fingerprint scanning capability. The portable device of FIG. 1 can be modified for playing audio or video files. Processing unit 2 can perform encryption, decryption, and other content-protection functions for the storage medium, when the content files are stored in memory device 3.

Electronic data storage medium device 10 has audio capability and can function as a media player such as an MP3 player. Video unit 14 allows video files to be received from the license server and played as a video stream. Display unit 6 may display the video, or a jack can allow an external display device to be driven. The video stream may have both video and audio, and may use audio unit 4 or its own audio decoder.

Video files may use formats such as MPEG-4 and JPEG. Files of these formats are sent to video unit 14 for decoding and playback after decryption. When the decrypted file has an audio format, the decrypted file is sent to audio unit 12 rather than to video unit 14. Audio unit 12 and video unit 14 can share some functional blocks and could be merged together in some embodiments. Some functions may be performed by processing unit 2, or by special functional blocks such as encryption engines that could be shared by both audio unit 12 and video unit 14.

Electronic data storage medium device 10′ can be accessed by external computer 9, and includes card body 1, processing unit 2, memory device 3, audio unit 4, input/output interface circuit 5, display unit 6, power source 7, and function key set 8 as described earlier for FIG. 1.

Processing unit 2 connects to other components and can operate in various modes, such as a programming mode, a data retrieving mode, and a data-resetting mode. Power source 7 supplies electrical power to processing unit 2. Function key set 8 allows the user to input a password that is verified by processing unit 2. Display unit 6 shows the operating status of the electronic data storage medium.

Fingerprint sensor 4 scans a fingerprint of a user to generate fingerprint scan data. The fingerprint scan can be used to verify a human user of the media player. Theft of the media player can be deterred since other users cannot use the media player since their fingerprints would not match that of the authorized user.

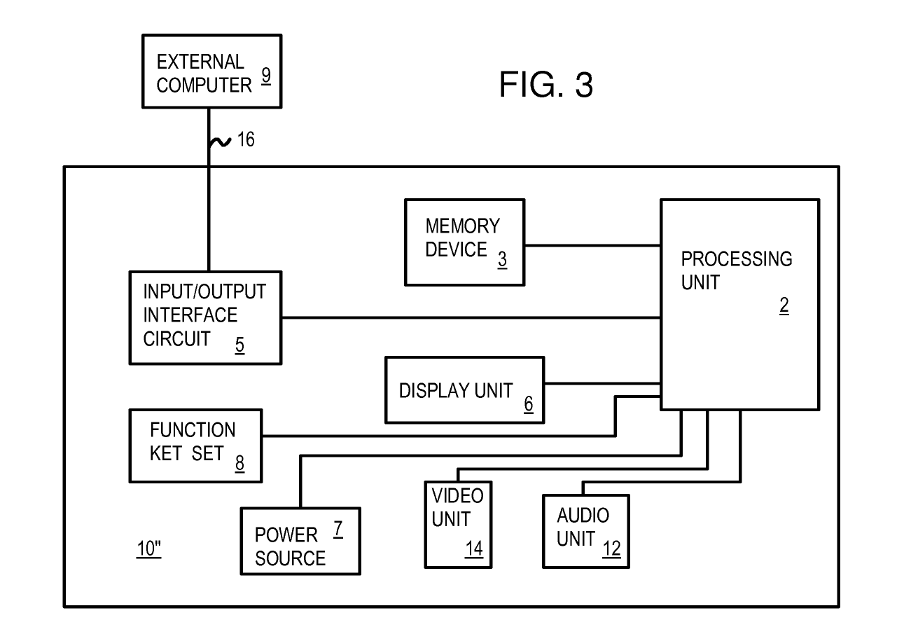

FIG. 3 shows an electronic data storage medium device with video and audio capability without a fingerprint sensor. The portable device of FIG. 2 can be further modified to provide content protection without a fingerprint sensor. Processing unit 2 can perform encryption, decryption, and other content-protection functions for the storage medium, when the content files are stored in memory device 3.

Electronic data storage medium device 10″ has audio capability and can function as a media player such as an MP3 player. Video unit 14 allows video files to be received from the license server and played as a video stream. Display unit 6 may display the video, or a jack can allow an external display device to be driven. The video stream may have both video and audio, and may use audio unit 4 or its own audio decoder.

Video files may use formats such as MPEG-4 and JPEG. Files of these formats are sent to video unit 14 for decoding and playback after decryption. When the decrypted file has an audio format, the decrypted file is sent to audio unit 12 rather than to video unit 14. Audio unit 12 and video unit 14 can share some functional blocks and could be merged together in some embodiments. Some functions may be performed by processing unit 2, or by special functional blocks such as encryption engines that could be shared by both audio unit 12 and video unit 14.

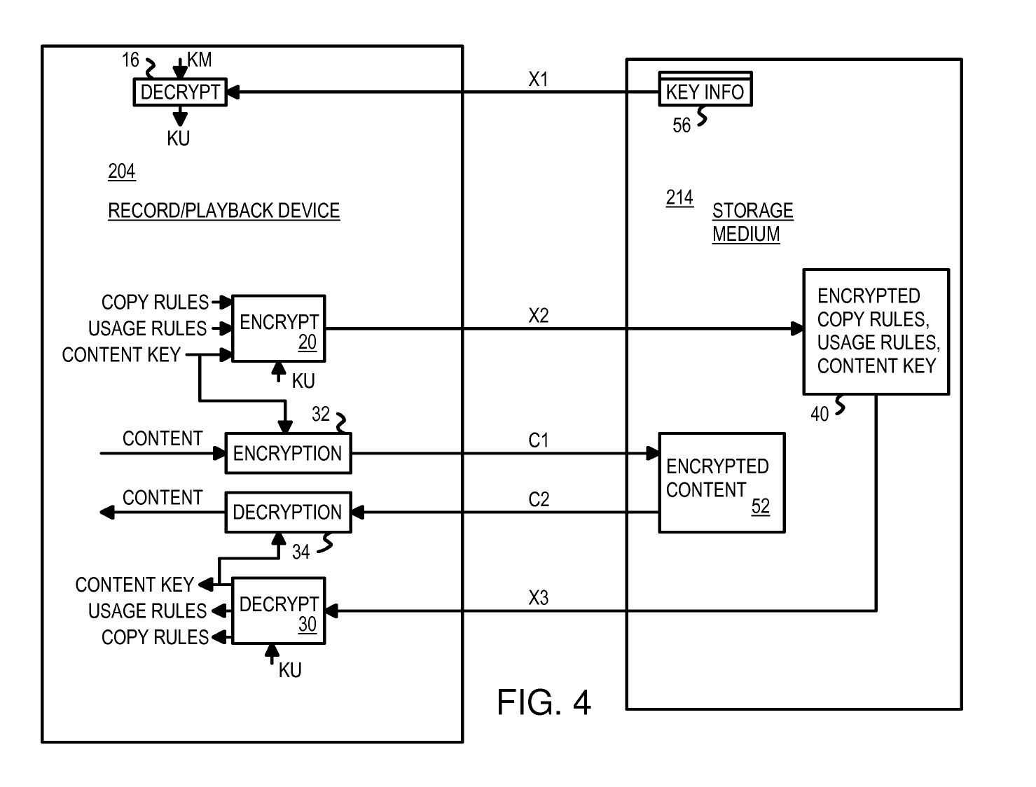

FIG. 4 shows a content-protection mechanism that does not pass unencrypted keys between a recording and playback device and a storage medium. Passing keys that are not encrypted over the interface between record/playback device 204 and storage medium 214 can expose these keys to interception by a determined hacker. Content keys are encrypted or combined with other data before being transmitted over the interface to confuse hackers. Row and column addresses of device keys in a key matrix are sent over the interface rather than the device keys themselves.

Record/playback device 204 reads key information 56 which is a key matrix that can generate approximately one million keys. Rows and columns within the key matrix contain keys or bytes in a key that is formed from bytes at several row, column locations in the key matrix. The key matrix is loaded during manufacture or setup and may not be readable by external devices for added security.

Record/playback device 204 reads a portion of pre-recorded data on storage medium 214 that contains key information 56. Key information 56 is sent to record/playback device 204 as transfer X1.

Record/playback device 204 receives transfer X1 and uses the row and column locations from storage medium 214 to locate one or more keys in its key matrix KM. Matrix decryptor 16 combines these keys from key matrix KM to generate a unique key KU.

During recording, record/playback device 204 uses unique key KU to encrypt a content key along with copy and usage rules for a particular content file. Key encryptor 20 generates encrypted key X2 that contains the content key, usage and copy rules encrypted with unique key KU. Encrypted key X2 is sent over the interface to record/playback device 204 and is stored as encrypted content key and rules 40.

The content, contained in one or more files from a content provider, is encrypted by content encryptor 32 with the content key that is also provided by the content provider. Encrypted content C1 is generated and sent over the interface to storage medium 214 for storage as encrypted content 52.

For downloaded media content, the encryption function of content encryptor 32 may be performed by the content provider or another server before downloading, so that encrypted content C1 is downloaded from the content provider to record/playback device 204, rather than being encrypted by record/playback device 204. For local content, content encryptor 32 can perform encryption. Encryption of the content key by encrypted key X2 could also be performed by the content provider or server before downloading, rather than by record/playback device 204, if the unique key KU can be determined by the content provider. Otherwise, record/playback device 204 performs encryption of the content key.

Since both encrypted content key and rules 40 and encrypted content 52 are encrypted, the content is stored in a protected form on storage medium 214.

For playback, record/playback device 204 reads encrypted content key and rules 40 from storage medium 214 as encrypted key X3 that is sent over the interface. Key decryptor 30 uses unique key KU from matrix decryptor 16 to recover the content key and the usage and copy rules.

Record/playback device 204 also reads encrypted content 52 from storage medium 214 as encrypted content C2. Content decryptor 34 uses the content key recovered by key decryptor 30 to decrypt the content stored on storage medium 214, which can now be played by record/playback device 204.

The usage and copy rules are enforced by record/playback device 204. For example, the usage rules may limit a number of times that the content can be played by record/playback device 204, or may specify and expiration date or time period. When these usage limits are exceeded, record/playback device 204 blocks playback of the content. A play counter or timer may be kept by record/playback device 204 for each content file, and could be combined with the usage rules and stored as part of encrypted content key and rules 40. Copy rules limiting a number of copies that can be made can similarly be checked and enforced.

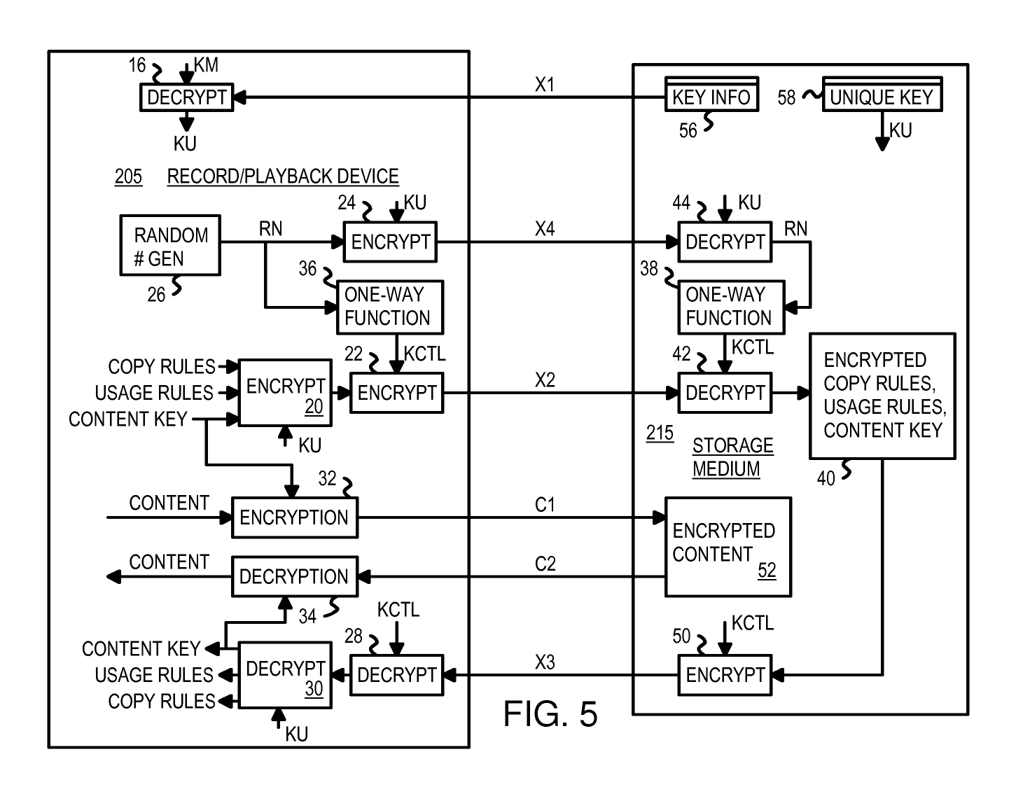

FIG. 5 shows a content-protection mechanism enhanced by a control key generated from a random-number generator. During manufacture or setup, unique key 58 (KU) is pre-loaded into storage medium 215 into a register or a part of the storage medium that cannot be externally read. Unique key 58 pre-loaded into storage medium 215 should match unique key KU generated by matrix decryptor 16 on record/playback device 205; otherwise incorrect keys are generated, preventing proper playback.

An additional level of encryption of encrypted keys X2, X3 is provided by key encryptor 22, which generates encrypted key X2 from the encrypted content key and rules generated by key encryptor 20 using control key KCTL. Thus encrypted key X2 is doubly-encrypted, using unique key KU and control key KCTL.

When storage medium 215 receives the doubly-encrypted encrypted key X2, key decryptor 42 uses a control key internally generated by storage medium 215 to recover encrypted content key and rules 40, which are stored. During playback, encrypted content key and rules 40 are read and then encrypted using control key KCTL by key encryptor 50 to generate doubly-encrypted key X3 that is sent over the interface. Record/playback device 205 uses its control key KCTL and key decryptor 28, and then unique key KU and key decryptor 30 to recover the content key and rules that content decryptor 34 uses to recover the contents for playback.

Additional security is provided by using both unique key KU and control key KCTL to encrypt keys X2, X3 before sending over the interface.

Control key KCTL is generated from a random number RN provided by random-number generator 26 on record/playback device 205. One-way function 36 can be a hash or similar function that generates control key KCTL from RN. Random number RN is also encrypted by RN encryptor 24 using unique key KU to generate encrypted random number X4 that is sent over the interface.

RN decryptor 44 on storage medium 215 receives encrypted random number X4 and uses unique key KU to recover random number RN. One-way function 38 is the same function performed by one-way function 36 on record/playback device 205. One-way function 38 generates a local control key KCTL from the recovered RN. Since the same one-way function is used on both record/playback device 205 and storage medium 215, using the same RN input, the two control keys KCTL match. Thus storage medium 215 generates its own local copy of control key KCTL from encrypted random number X4, without sending control key KCTL over the interface, hiding control key KCTL from hackers at the interface.

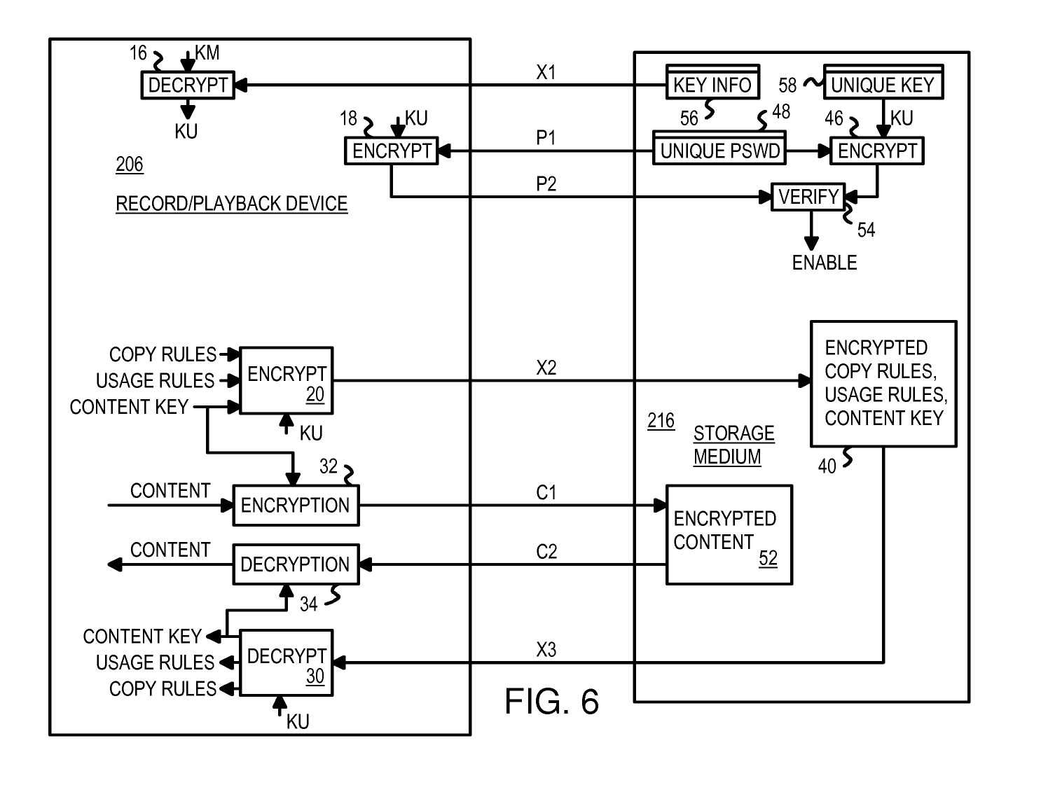

FIG. 6 shows a content-protection mechanism that compares local unique keys by encrypting a password. During manufacture or setup, unique key 58 (KU) is pre-loaded into storage medium 216 into a register or a part of the storage medium that cannot be externally read. Unique key 58 pre-loaded into storage medium 216 should match unique key KU generated by matrix decryptor 16 on record/playback device 205; otherwise incorrect keys are generated, preventing proper playback.

To verify that the unique keys from both the playback device and the storage medium match, a unique password is encrypted by both unique keys and compared. Pre-recorded unique password 48 is stored on storage medium 216 during manufacture or initial setup. Password encryptor 46 uses unique key KU stored on storage medium 216 to encrypt unique password 48 to generate a locally-encrypted password.

Pre-recorded unique password 48 is also sent as password P1 from storage medium 216 to record/playback device 206 over the interface, and is encrypted on record/playback device 206 by device password encryptor 18. The unique key KU generated by matrix decryptor 16 stored is used to encrypt unique password 48 to generate a player-encrypted password P2.

Verifier 54 receives player-encrypted password P2 from record/playback device 206 and compares it to the locally-encrypted password from password encryptor 46. When the encrypted passwords match, the unique keys KU on both the player and the storage medium match. Accessing of encrypted content 52 and encrypted content key and rules 40 can be enabled as described for FIG. 4. However, when the encrypted passwords do not match, the unique keys KU differ. Access of encrypted content 52 and encrypted content key and rules 40 are disabled. Thus a device or storage medium with the wrong unique key KU, such as might be generated from corrupted or revoked keys, cannot be used.

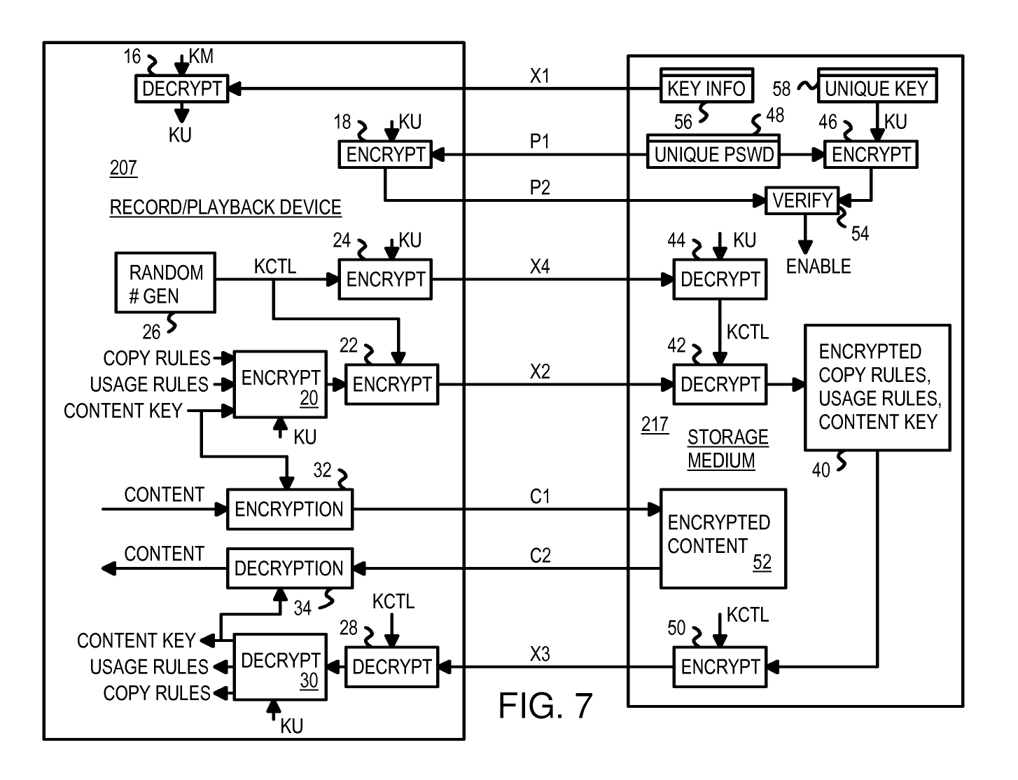

FIG. 7 shows a content-protection mechanism that compares local unique keys by encrypting a password and uses a control key generated from a random-number generator. The password checking of FIG. 6 is combined with the second level of encryption using the control key generated from the random number, as described for FIG. 5. However, rather than use one-way functions 36, 38, control key KCTL is the random number RN generated by random-number generator 26. Encrypted random number X4 sent over the interface is the control key encrypted by unique key KU. Decryptor 44 locally generates control key KCTL directly for use by key decryptor 42.

Key encryptors 22, 50 and key decryptor 42, 28 operate as described for FIG. 5, using control key KCTL to doubly-encrypt the content key. Additional security is provided by using both unique key KU and control key KCTL to encrypt keys X2, X3 before sending over the interface.

Security is further enhanced by comparing and verifying the unique password encrypted with unique keys KU from both the player and the storage medium. Unique password 48 is sent over the interface and encrypted by device password encryptor 18 to generate player-encrypted password P2 as described for FIG. 6. Verifier 54 receives player-encrypted password P2 from record/playback device 207 and compares it to the locally-encrypted password from password encryptor 46 to enable or disable access of encrypted content 52 and encrypted content key and rules 40.

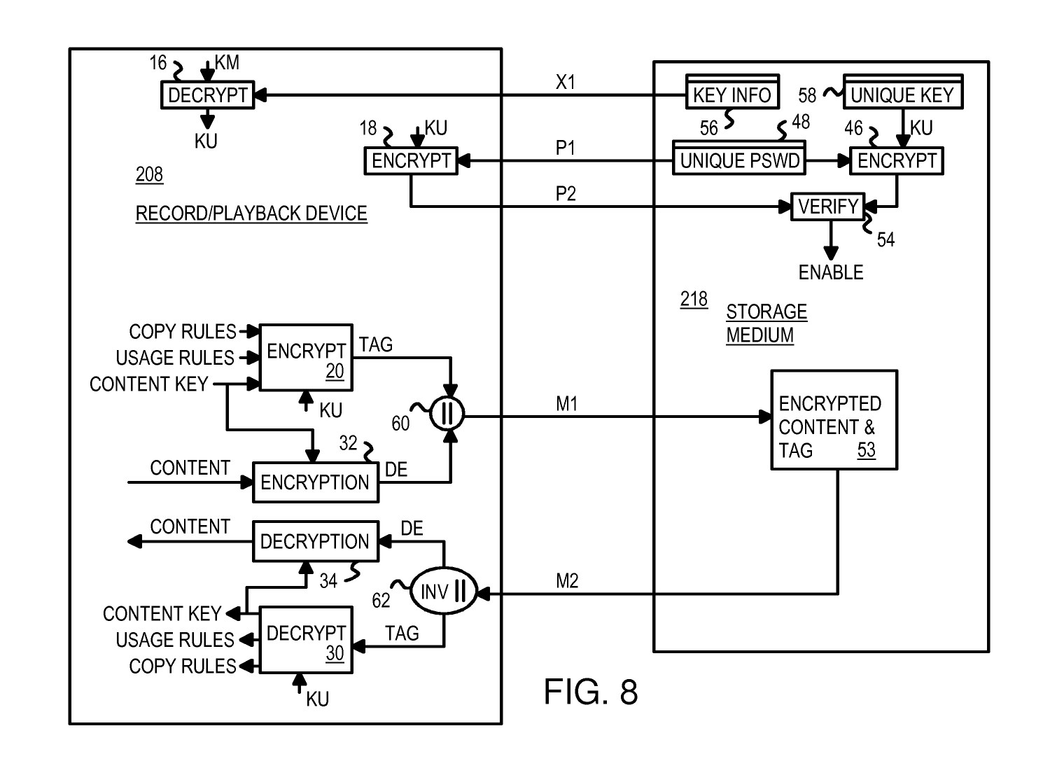

FIG. 8 shows a content-protection mechanism that concatenates an encrypted tag with the encrypted content before transfer over a less-secure interface. Key encryptor 20 receives the content key, usage and copy rules and encrypts them using unique key KU to generate an encrypted tag TAG. Content encryptor 32 uses the content key to encrypt the content as encrypted content DE. Concatenator 60 combines the TAG from key encryptor 20 with encrypted content DE from content encryptor 32 to generate merged content M1 that is sent over the interface. Storage medium 218 stores merged content M1 as encrypted content and tag 53.

On playback, record/playback device 208 reads encrypted content and tag 53 as merged content M2. Separator 62 separates encrypted content DE from encrypted tag TAG. Concatenator 60 and separator 62 can use complementary methods, such as defining the first 4K bytes of merged content M1, M2 as the TAG, with the remainder being encrypted content DE. Concatenator 60 and separator 62 could interleave TAG with encrypted content DE or could use some other deterministic method of combining and separating TAG and DE.

Having DE and TAG combined further enhances security, since a hacker does not know how they are combined, especially when interleaved.

Security is further enhanced by comparing and verifying the unique password encrypted with unique keys KU from both the player and the storage medium. Unique password 48 is sent over the interface and encrypted by device password encryptor 18 to generate player-encrypted password P2 as described for FIG. 6. Verifier 54 receives player-encrypted password P2 from record/playback device 208 and compares it to the locally-encrypted password from password encryptor 46 to enable or disable access of encrypted content 52 and encrypted content key and rules 40.

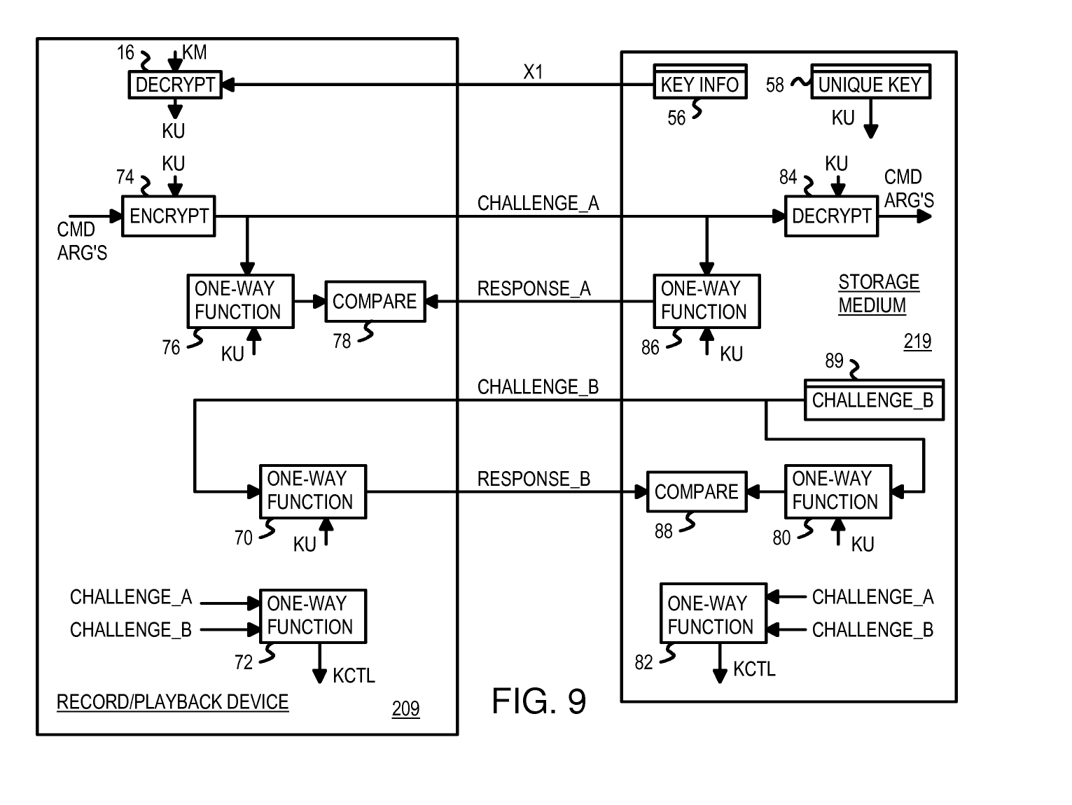

FIG. 9 highlights a content-protection mechanism using challenges and responses to generate a control key. Unique keys KU are generated on both record/playback device 209 and storage medium 219. Key information 56 contains row and column locations for key matrix KM, allowing matrix decryptor 16 to generate unique key KU.

During manufacture or setup, unique key 58 (KU) is pre-loaded into storage medium 219 into a register or a part of the storage medium that cannot be externally read. Unique key 58 pre-loaded into storage medium 219 should match unique key KU generated by matrix decryptor 16 on record/playback device 209;

Challenge encryptor 74 in record/playback device 209 uses unique key KU to encrypt command arguments to generate challenge_A. Challenge_A is sent over the interface to storage medium 219 and decrypted by decryptor 84 using unique key KU to recover the command arguments. The command arguments may be used by storage medium 219 to control or modify its operation.

On record/playback device 209, challenge_A is input to one-way function 76, which uses a hash or other lossy function with unique key KU to generate a response match value that is applied to comparator 78.

On storage medium 219, challenge_A is input to one-way function 86, which uses the same lossy function as one-way function 76. One-way function 86 uses unique key KU to generate response_A that is sent over the interface as response_A and also applied to comparator 78. Comparator 78 compared response_A to the response match value from one-way function 76. Access of record/playback device 209 is disabled if response values do not match.

Storage medium 219 has challenge_B 89 pre-loaded during manufacture or setup. Challenge_B is sent over the interface to record/playback device 209, which uses one-way function 70 to generate response_B. Response_B is sent back over the interface to comparator 88 in storage medium 219.

In storage medium 219 one-way function 80 uses unique key KU to generate a response value from challenge_B. The response value from one-way function 80 is input to comparator 88 and compared to response_B. Access of record/playback device 209 is disabled if response_B values do not match.

In record/playback device 209, control key KCTL is generated by key encryptor 72 using challenge_A and challenge_B as inputs. In storage medium 219, control key KCTL is generated by key encryptor 82 from challenge_A and challenge_B.

Control key KCTL is used by key encryptors 20, 22, 50, and key decryptors 30, 42, 28 (not shown) to doubly-encode encrypted keys as described and shown for FIG. 5. Content is encrypted by content encryptor 32 and decrypted by content decryptor 34 and stored as encrypted content 52 as shown and described in FIG. 5.

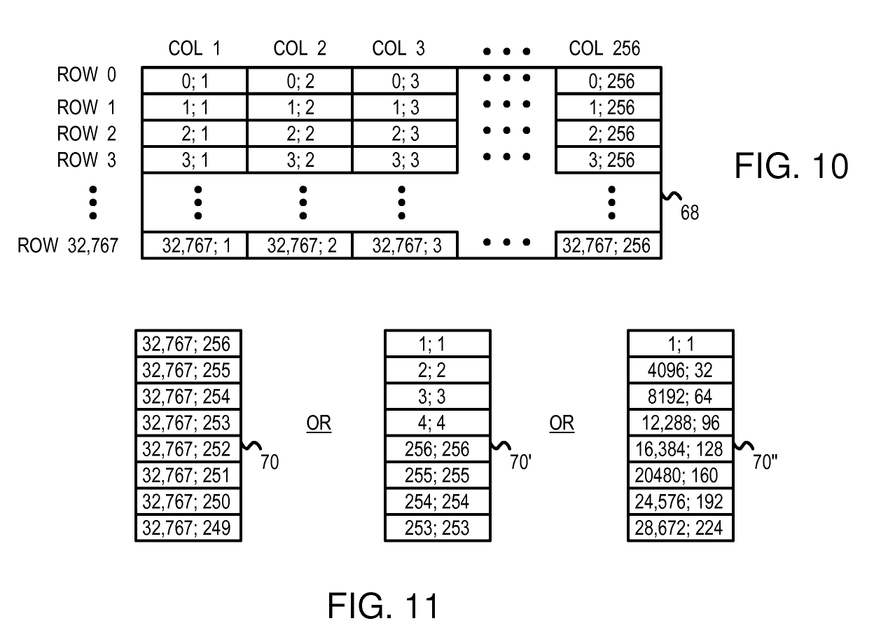

FIG. 10 shows a key matrix. Key matrix 68 is pre-loaded into record/playback device 204-209 and used by matrix decryptor 16 to generate unique key KU. Key information 56 from storage medium 214-219 contains row and column information to locate parts of keys within key matrix 68.

Key matrix 68 has 32,768 rows and 256 columns. Each cell contains 4 bytes of key data. Each record/playback device can be assigned 8 unique keys, allowing over 1 million unique key combinations.

FIG. 11 shows three examples of key combinations. Key set 70 contains 8 unique keys KU that are generated from columns 249-256 of last row 32,767. Key set 70′ contains another 8 unique keys KU that are generated from the first and last 4 columns and the first and last 4 rows. Key set 70″ contains 8 unique keys KU that are generated as multiples of 32 columns and multiples of 4K rows.

Keys can be revoked by a central license agency or server by over-writing key information 56 in the storage medium with invalid combinations of rows and columns, or by over-writing data bytes in key matrix 68 with invalid key data. The wrong unique key KU is generated when keys are revoked, preventing access.

### ALTERNATE EMBODIMENTS

Several other embodiments are contemplated by the inventors. For example mediums without a local medium controller can have key information 56 and key KU pre-loaded directly onto the medium, such as for a DVD. While combination recording and playback devices have been shown, record-only or playback-only devices could be substituted using a subset of the components of the combination devices. Combinations, simplifications, or enhancements of the various mechanisms could be used. Some devices may store a fixed unique password, while others modify the password, such as with information from a fingerprint scan. Verifying a fingerprint scan could be another mechanism to disable the device or access of the storage medium when the wrong fingerprint is scanned.

Functions may be performed by hardware, software executed by the processing unit or by other units, firmware, or various combinations. Decoders could be added or modified to support other formats, such as a future MPEG-8 or MP8 format (or some other number or name) that might be developed in the future. The audio unit could have a receiver built-in, such as for receiving radio broadcasts over AM or FM or other bands. Other functions could be added to the media player, such as video, telephone, wireless Internet access, WiFi, Wii, an RF transceiver, etc.

A music player may include a controller for playing audio from MP3, MP4, or other data stored in the flash memory that acts as the storage medium. An audio jack may be added to the device to allow a user to plug in headphones to listen to the music. A wireless transmitter such as a BlueTooth transmitter may be added to the device to connect to wireless headphones rather than using the audio jack. Infrared transmitters such as for IRDA may also be added. A BlueTooth transceiver to a wireless mouse, PDA, keyboard, printer, digital camera, MP3 player, or other wireless device may also be added. The BlueTooth transceiver could replace the connector as the primary connector. A Bluetooth adapter device could have a connector, a RF (Radio Frequency) transceiver, a baseband controller, an antenna, a flash memory (EEPROM), a voltage regulator, a crystal, a LED (Light Emitted Diode), resistors, capacitors and inductors. These components may be mounted on a printed-circuit board (PCB) before being enclosed into a plastic or metallic enclosure.

While audio files and decoding have been described, video files could also be substituted, or considered to be a superset of audio, since video often has an audio track. Still photos such as JPEG could also benefit from content protection and be processed in a similar fashion. The record/playback device could connect to the Internet, either directly or through a host such as a PC. The storage medium could include a flash memory on a removable card or module, or could include a rotating disk, either magnetic or optical, or could use some other storage technology. Various circuitry and components may be integrated with the storage medium, such as encryptors and processors. The player could be physically integrated with the storage medium, or could include mechanical and electrical parts to access the storage medium. The storage medium could have multiple parts, such as multiple flash-memory chips or multiple disks.

Keys could be generated only once, such as the first time the media player is used, or more often, such as each time a new account is set up on a license server, or periodically, such as once per year, or after a command from the license server. Various intermediate values and encryption keys, or partial keys, may be used.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A content-protected player system comprising:
a storage medium for storing encrypted content and for storing an encrypted content key, wherein a content key is an encryption key for decrypting the encrypted content to generate recovered content for playback;
pre-loaded key information stored on the storage medium;
an interface between the storage medium and a playback device;
wherein the playback device comprises:
a unique key generator, receiving the pre-loaded key information sent over the interface, for generating a unique key;
a key decryptor, receiving the encrypted content key sent over the interface, for generating a recovered content key from the encrypted content key using the unique key for decryption; and
a content decryptor, receiving the encrypted content sent over the interface, for generating recovered content for playback using the recovered content key for decryption,
wherein the unique key is not sent over the interface to secure the interface;
wherein the content key is not sent over the interface except as the encrypted content key.

2. The content-protected player system of claim 1 further comprising:
a pre-loaded unique key stored on the storage medium;
a unique password stored on the storage medium and sent over the interface to the playback device;
a first password encryptor on the playback device that uses the unique key to encrypt the unique password sent over the interface to generate a player-encrypted password;
a second password encryptor on the storage medium that uses the pre-loaded unique key to encrypt the unique password to generate a medium-encrypted password;
a verifier that receives the medium-encrypted password and the player-encrypted password and disables access of the encrypted content when a mismatch is detected,
whereby unique keys encrypt the unique password for verification.

3. The content-protected player system of claim 1 further comprising:
a secondary key encryptor that further encrypts the content key using a control key to generate the encrypted content key sent over the interface;
wherein the key decryptor further comprises a secondary key decryptor that uses the control key to further decrypt the encrypted content key sent over the interface, wherein the recovered content key is decrypted using both the unique key and the control key;
a medium decryptor, on the storage medium, for partially decrypting the encrypted content key sent over the interface using a medium control key before storage in the storage medium as the encrypted content key;
a medium encryptor, on the storage medium, for using the medium control key to doubly encrypt the encrypted content key stored in the storage medium before sending over the interface as the encrypted content key;
whereby the encrypted content key is doubly encrypted using the control key for transmission over the interface.

4. The content-protected player system of claim 3 further comprising:
a pre-loaded unique key stored on the storage medium;
a random number generator on the playback device that generates a random number;
a first function that generates the control key on the playback device from the random number using a predetermined function;
a random-number encryptor that uses the unique key to encrypt the random number for transmission over the interface;
a random-number decryptor, on the storage medium, that uses the pre-loaded unique key to decrypt the random number sent over the interface to generate a recovered random number; and
a second function, on the storage medium, that generates the medium control key from the recovered random number using the predetermined function,
whereby the control key and the medium control key are separately generated from the random number that is encrypted for transmission over the interface,
wherein the control key is not sent over the interface.

5. The content-protected player system of claim 4 wherein the predetermined function is a pass-through function;
wherein the control key is the random number.

6. The content-protected player system of claim 4 wherein the predetermined function is a one-way lossy function;
wherein the control key differs from the random number and wherein the random number cannot be generated from the control key due to the one-way lossy function.

7. The content-protected player system of claim 4 further comprising:
a unique password stored on the storage medium and sent over the interface to the playback device;
a first password encryptor on the playback device that uses the unique key to encrypt the unique password sent over the interface to generate a player-encrypted password;
a second password encryptor on the storage medium that uses the pre-loaded unique key to encrypt the unique password to generate a medium-encrypted password;
a verifier that receives the medium-encrypted password and the player-encrypted password and disables access of the encrypted content when a mismatch is detected,
whereby unique keys encrypt the unique password for verification.

8. The content-protected player system of claim 3 further comprising:
a pre-loaded unique key stored on the storage medium;
a first challenge generated by the playback device and sent over the interface to the storage medium;
a second challenge on the storage medium and sent over the interface to the playback device;
a first player one-way function generator, on the playback device and receiving the first challenge, for generating a first function value using a lossy one-way function;
a second player one-way function generator, on the playback device and receiving the second challenge, for generating a second response value using the lossy one-way function;
a first medium one-way function generator, on the storage medium and receiving the first challenge, for generating a first response value using the lossy one-way function;
a second medium one-way function generator, on the storage medium and receiving the second challenge, for generating a second function value using the lossy one-way function;
a first comparator for comparing the first response value to the first function value and disabling access of the storage medium when a mis-compare is detected;
a second comparator for comparing the second response value to the second function value and disabling access of the storage medium when a mis-compare is detected;
a player control key generator, on the playback device, for generating the control key from the first challenge and from the second challenge using a lossy function; and
a medium control key generator, on the storage medium, for generating the medium control key from the first challenge and from the second challenge using the lossy function,
whereby challenges and response are transmitted over the interface to generate the control key.

9. The content-protected player system of claim 8 wherein the first player one-way function generator receives the unique key to alter the lossy one-way function to generate the first function value from the first challenge;
wherein the second player one-way function generator receives the unique key to alter the lossy one-way function to generate the second response value from the second challenge;
wherein the first medium one-way function generator receives the pre-loaded unique key to alter the lossy one-way function to generate the first response value from the first challenge;
wherein the second medium one-way function generator receives the pre-loaded unique key to alter the lossy one-way function to generate the second function value from the second challenge;
whereby the unique key alters the lossy one-way function so that the first and second response values and the first and second function values are functions of the unique key.

10. The content-protected player system of claim 8 further comprising:
a first challenge generator, on the playback device, for generating the first challenge from command arguments using the unique key for encryption;
a first challenge decoder, on the storage medium, for generating recovered command arguments by using the pre-loaded unique key to decrypt the first challenge.

11. The content-protected player system of claim 2 further comprising:
a combiner, receiving encrypted content and the encrypted content key, for combining the encrypted content with the encrypted content key to generate a merged content for transmission over the interface and for storage in the storage medium;
a splitter, receiving the merged content stored on the storage medium and sent over the interface, for spitting the merged content to generate encrypted content input to the content decryptor and the encrypted content key input to the key decryptor;
whereby the encrypted content and the encrypted content key are merged for transmission over the interface.

12. The content-protected player system of claim 2 further comprising:
a key matrix, pre-loaded into the playback device, having a matrix of key data in rows and columns;
wherein the pre-loaded key information sent over the interface from the storage medium comprises row and column identifiers;
wherein the unique key generator generates the unique key from key data located in the key matrix by the row and column identifiers sent over the interface,
wherein the unique key is not sent over the interface.

13. The content-protected player system of claim 2 further comprising:
a key encryptor for generating the encrypted content key sent over the interface by using the unique key to encrypt the content key, copy rules, and usage rules;
wherein the key decryptor further generates recovered copy rules and recovered usage rules from the encrypted content key;
wherein the copy rules indicate a limited number of copies of the encrypted content;
wherein copy rules and usage rules are encrypted with the content key.

14. A content-protection media player comprising:
input/output interface circuit means for connecting to a host;
processor means for executing instructions;
memory means for storing an encrypted media file received by the input/output interface circuit means;
decrypt means for decrypting the encrypted media file using a content key to generate playable media;
decoder means for generating signals representing the playable media from the decrypt means;
function key means for receiving inputs from a user to control operation of the processor means;
display means for displaying control information to the user generated by the processor means;
audio means, receiving the signals from the decoder means, for generating audible sounds to the user representing the playable media and encrypted in the encrypted media file;
unique key generate means for generating a unique key from key information stored by the memory means;
key encryptor means for generating an encrypted key from the content key and content rules using the unique key for encryption; and
key decryptor means for recovering the content key from the encrypted key stored by the memory means using the unique key for decryption.

15. The content-protection media player of claim 14 wherein the key encryptor means further comprises secondary key encryption means for doubly encrypting the encrypted key using a control key and with the unique key;
wherein the key decryptor means further comprises secondary key decryption means for using both the unique key and the control key for decryption;
storage key decryptor means, coupled to the memory means, for partially decrypting the encrypted key using a storage control key before storage of the encrypted key; and
storage key encryptor means, coupled to the memory means, for doubly encrypting the encrypted key read from the memory means using the storage control key before transmission to the key decryptor means as the encrypted key,
whereby the encrypted key is doubly encrypted for transmission.

16. The content-protection media player of claim 15 further comprising:
stored unique key means for storing a stored unique key in the memory means, wherein the stored unique key and the unique key match;
random number generator means for generating a random number;
random number encryption means, receiving the random number, for generating an encrypted random number using the unique key for encryption; and
random number decryption means, receiving the encrypted random number, for generating a recovered random number using the stored unique key for decryption.

17. The content-protection media player of claim 16 wherein the control key is the random number and the storage control key is the recovered random number, or wherein the control key is generated as a lossy function of the random number and the storage control key is generated as the lossy function of the recovered random number.

18. The content-protection media player of claim 14 further comprising:
fingerprint sensor means for scanning a fingerprint of the user of the content-protection media player;
a fingerprint comparator for comparing a current scan from the fingerprint sensor to a stored scan of a fingerprint in a security register;
wherein the fingerprint comparator disables the decrypt means and prevents generation of the playable media when the fingerprint comparator does not match the current scan to the stored scan,
whereby fingerprint scanning secures the content-protection media player from use by an unauthorized user.

19. A method for protecting encrypted content on a media player comprising:
reading a key pointer; from a storage medium and sending the key pointer over an interface to a playback device;
locating key bytes in a key storage structure that are pointed to by the key pointer to generate a unique key;
generating a control key from a random number;
encrypting the control key with the unique key to generate an encrypted control key;
sending the encrypted control key over the interface to the storage medium and decrypting the encrypted control key using a stored unique key to generate a storage control key;
doubly encrypting a content key and content rules using both the control key and the unique key to generate a transmission key;
sending the transmission key over the interface to the storage medium;
partially decrypting the transmission key using the storage control key to generate a stored key and storing the stored key in the storage medium;
reading the stored key from the storage medium and further encrypting the stored key using the storage control key to generate a second transmission key;
sending the second transmission key over the interface to the playback device;
decrypting the second transmission key using both the control key and the unique key to generate a recovered content key and recovered rules;
reading encrypted content stored on the storage medium and sending the encrypted content over the interface to the playback device;
decrypting the encrypted content received by the playback device using the recovered content key to generate playable media; and
playing the playable media to a user of the media player.

20. The method of claim 19 further comprising:
reading a unique password from the storage medium and sending the unique password over the interface to the playback device;
encrypting the unique password on the playback device using the unique key to generate a first verify value;
encrypting the unique password on the storage medium using the stored unique key to generate a second verify value;
comparing the first verify value to the second verify value and disabling access of the storage medium by the playback device when a mis-compare is detected,
whereby the unique key and the stored unique key are verified to enable access of the storage medium.
